(19) United States
(12) Patent Application Publication
(10) Pub. No.: US 2013/0182471 A1
(43) Pub. Date: Jul. 18, 2013

(54) OVERVOLTAGE PROTECTION CIRCUIT FOR AT LEAST ONE BRANCH OF A HALF-BRIDGE, INVERTER, DC/DC VOLTAGE CONVERTER AND CIRCUIT ARRANGEMENT FOR OPERATING AN ELECTRICAL MACHINE

(71) Applicants: Albrecht Schwarz, Rutesheim (DE); Heiner Jacobs, Baden-Baden (DE)

(72) Inventors: Albrecht Schwarz, Rutesheim (DE); Heiner Jacobs, Baden-Baden (DE)

(21) Appl. No.: 13/811,958

(22) PCT Filed: May 13, 2011
(86) PCT No.: PCT/EP2011/057760

§ 371 Date: Apr. 3, 2013

(30) Foreign Application Priority Data
Jul. 28, 2010 (DE) 10 2010 038 511.5

(51) Int. Cl. H02H 9/04; H02M 1/32

(52) U.S. Cl. CPC H02H 9/04; H02M 1/32
USPC 363/56.01; 361/91.5; 363/50

(57) ABSTRACT

An overvoltage protection circuit is provided for at least one branch of a half-bridge which includes a controllable semiconductor switch element and a free-wheeling diode connected in series and situated on a common circuit substrate. The protection circuit includes a commutation branch connected in parallel with the half-bridge branch, the commutation branch including at least one commutation capacitor also situated on the circuit substrate.

### BACKGROUND OF THE INVENTION

1. Field of the Invention

The present invention relates to an overvoltage protection circuit for at least one branch of a half-bridge, an inverter, a d.c./d.c. voltage converter, as well as a circuit arrangement for operating an electrical machine.

2. Description of the Related Art

As a rule, electrical machines in the form of polyphase machines, which are operated in conjunction with d.c./a.c. inverters that are often also referred to as inverters, are used for propulsion in hybrid or electric vehicles. In this context, the electrical machines are selectively operated in motor mode or generator mode. In motor mode, the electrical machine generates a drive torque, which, when used in a hybrid vehicle, assists an internal combustion engine, for example, in an acceleration phase. In generator mode, the electrical machine generates electrical energy, which is stored in an energy storage mechanism, such as a battery or a super cab. The operating mode and power of the electrical machine are set by a control unit, using the inverter.

For each phase (U, V, W) of the electrical machine, in which case the number of phases may be 1-n, known inverters include a half-bridge, with the aid of which the specific phase of the electrical machine may be selectively connected to a high potential, the so-called intermediate circuit voltage, or to a low reference potential, in particular, ground. In this context, each half-bridge includes two parallelly connected half-bridge branches, which each include a series connection of a controllable semiconductor switch element (power switch), e.g., in the form of a MOSFET or IGBT, and a non-controllable semiconductor switch element in the form of a free-wheeling diode. The power switches in the individual half-bridge branches are controlled by an external control unit, which calculates a desired operating point for the electrical machine as a function of the driver's input (accelerating or braking).

Depending on whether a power switch in a half-bridge branch is open or closed, a load current in the form of the phase current reverses direction inside of the half-bridge branch, from the power switch to the serially connected free-wheeling diode, or vice versa. During these reversals of direction, in each instance, voltage surges occur at the decommutating semiconductor switch elements, that is, at the semiconductor switch elements at which the flow of current is ended; the magnitude of the voltage surges being a function of the switching rate of the power switches and the magnitude of parasitic inductances, which are generated by electrical connections between the components. In the power class used in hybrid or electric vehicles, the switching frequency of the inverter is presently in the range of 10 kHz, and in the case of pulse-controlled inverters, it is limited by the maximum degree of control, which is, in turn, a function of the switching rate and/or the switching time of the power switches. The switching times of customary power switches today are in the range of 150 to 200 ns in the case of a closing operation (closing), and in the range of 500 to 1000 ns in the case of a breaking operation (opening).

Published German patent application document DE 42 10 443 A1 describes a protective circuit for a traction-motor control device, which renders possible the protection of the inverter of a customary commutation set-up, but also limits or eliminates leakage currents, which load the internal elements of the inverter. To that end, a protective thyristor for blocking motor leakage currents is connected in series between a commutation thyristor and the inverter circuit. In addition, RC elements are connected in series with the commutation thyristor to limit inverter leakage currents.

### BRIEF SUMMARY OF THE INVENTION

The present invention provides an overvoltage protection circuit for at least one branch of a half-bridge, the branch including a controllable semiconductor switch element and a free-wheeling diode connected in series with it, which are situated on a common circuit substrate. According to the present invention, a commutation branch, which includes at least one commutation capacitor that is also situated on the circuit substrate, is connected in parallel with the half-bridge branch.

The present invention also provides an inverter, which includes semiconductor switch elements in the form of at least one half-bridge having, in each instance, two parallelly connected half-bridge branches; each half-bridge branch including a controllable semiconductor switch element and a free-wheeling diode connected in series with it. In this context, an overvoltage protection circuit of the present invention is provided for each half-bridge.

The present invention also provides a d.c./d.c. voltage converter, which includes semiconductor switch elements in the form of at least one half-bridge having, in each instance, two parallelly connected half-bridge branches; each half-bridge branch including a controllable semiconductor switch element and a free-wheeling diode connected in series with it. In this context, an overvoltage protection circuit of the present invention is provided for each half-bridge.

The present invention also provides a circuit arrangement for operating an electrical machine, which is controlled by an inverter; the inverter including circuit elements in the form of half-bridges each having two parallelly connected half-bridge branches, and in each instance, a half-bridge is electrically connected to a phase of the electrical machine. In this context, an overvoltage protection circuit of the present invention is provided for each half-bridge.

The present invention is based on the idea of damping voltage surges at the semiconductor switch elements of a half-bridge branch, which occur in response to commutating the load current from the power switch to the free-wheeling diode and vice versa, the damping being effected by parallelly connecting a commutation branch that includes at least one commutation capacitor. In this context, however, it must be taken into consideration that, in particular, in the case of high switching rates, the further away the commutation branch is from the semiconductor chip, the more voltage surges electrically load a semiconductor chip of a semiconductor switch element, i.e., a power switch or a free-wheeling diode. Thus, the present invention provides that the commutation capacitor be situated on the circuit substrate, on which the power switch and the free-wheeling diode of the corresponding half-bridge branch are also situated. In this manner, the commutation branch may be situated in direct proximity to the half-bridge branch, and therefore, may be connected to the half-bridge branch at an extremely low impedance.

In addition, positioning the commutation branch in direct proximity to the half-bridge branch has the advantage that in this manner, an EMC-compatible (EMC=electromagnetic compatibility) circuit configuration is ensured, since the half-bridge branch and the commutation branch surround only a small area.

In this context, the overvoltage protection circuit of the present invention may be used for both an individual half-bridge branch, as appears, for example, in a voltage reduction unit, and for an entire half-bridge having two parallel half-bridge branches, as is used, for example, in an inverter or a d.c./d.c. voltage converter.

If the commutation branch only includes one or more commutation capacitors, then these form parasitic resonant circuits together with parasitic inductances, which are generated by electrical connections between the individual components of the specific circuit arrangement. However, these parasitic resonant circuits may produce an unacceptable EMC loading as a function of the specific, respective circuit arrangements.

To damp such parasitic oscillations, the commutation branch may include at least one commutation resistor, which is connected in series with the commutation capacitor and is also situated on the circuit substrate.

In order to further reduce a maximum voltage increase at the commutation capacitor, and consequently, at the semiconductor switch elements as well, a further specific embodiment of the present invention provides that the commutation branch may include at least one commutation diode, which is connected in parallel with the commutation resistor and is also situated on the circuit substrate. Such a commutation diode produces an acceleration of the charging cycle, a deceleration of the discharging cycle and, therefore, further damping of voltage surges.

In order to prevent unwanted EMC loadings from the commutation branch, the commutation branch may also include at least one commutation coil, which is connected in series with the commutation capacitor and the commutation resistor and is also situated on the circuit substrate. This wiring configuration produces, in the commutation branch, a series resonant circuit, which, through suitable design of the individual circuit components, counteracts the parasitic resonant circuit, which is formed by the commutation capacitor and the parasitic inductances.

For a circuit arrangement, where an electrical machine is controlled by an inverter, in which case the inverter includes semiconductor switch elements in the form of half-bridges each having two parallelly connected half-bridge branches, and a half-bridge is electrically connected, in each instance, to a phase of the electrical machine, the present invention provides an overvoltage protection circuit of the present invention for each half-bridge.

According to one specific embodiment of a circuit arrangement of the present invention for operating an electrical machine controlled by an inverter, a d.c/d.c. voltage converter is connected in parallel with the inverter, and an intermediate circuit capacitor is connected in parallel with the d.c/d.c. voltage converter; the d.c/d.c. voltage converter advantageously being configured to have multiple phases. In this context, 1 to n phases are feasible as a function of the efficiency requirements of the converter. The converters may also be different in their power, in order to specially optimize the efficiency in the part-throttle ranges.

Inverters, which are used for controlling an electrical machine, are operated, as a rule, at an intermediate circuit voltage, which is in a range of, e.g., ±40% of the nominal voltage of an energy store, such as a traction battery. A high intermediate circuit voltage has the advantage that a specified power requirement is achievable using small phase currents and supply currents. However, since the nominal voltages of the usable energy stores may not be increased as needed, due to technological and economic reasons, a d.c/d.c. voltage converter may be used, which increases the voltage level of the energy store to a higher intermediate circuit voltage level, or vice versa, as a function of the operating mode of the electrical machine.

If a multiphase d.c/d.c. voltage converter, which includes several parallelly connected and advantageously identical d.c/d.c. voltage converters, is used for that purpose, then this has the advantage that each converter only has to carry a portion of the total current, which means that the size of charging inductors and other passive components of the d.c/d.c. voltage converters may be markedly reduced. As an alternative to, or in addition to using a multiphase d.c/d.c. voltage converter, a higher switching frequency may also be applied, which also results in smaller components being able to be used for the intermediate circuit capacitor and inductance coils. However, a higher switching frequency requires more rapid switching and consequently produces higher current gradients in the power switches and free-wheeling diodes of the half-bridge branches. However, the higher current gradients produce, in turn, an increase in the voltage surges at the semiconductor switch elements. For this reason, the overvoltage protection circuit of the present invention may be used in a particularly advantageous manner in such a circuit arrangement.

Further features and advantages of specific embodiments of the present invention are derived from the following description, with reference to the attached figures.

### BRIEF DESCRIPTION OF THE DRAWINGS

FIG. 1 shows a schematic block diagram of a related-art electrical machine controlled by an inverter.

FIG. 2 shows a half-bridge of an inverter, having parasitic inductances.

FIG. 3 shows an overvoltage protection circuit of the present invention for the half-bridge of FIG. 2.

FIG. 4 shows an exemplary, graphical representation of the phase current and the supply current of the circuit arrangement of FIG. 1, as a function of the intermediate circuit voltage (to size an electrical machine for a defined mechanical shaft power).

FIG. 5 shows a schematic block diagram of a related-art electrical machine, which is controlled by an inverter and includes a d.c/d.c. voltage converter.

FIG. 6 shows a detailed representation of the d.c/d.c. voltage converter from FIG. 5, having an overvoltage protection circuit of the present invention.

### DETAILED DESCRIPTION OF THE INVENTION

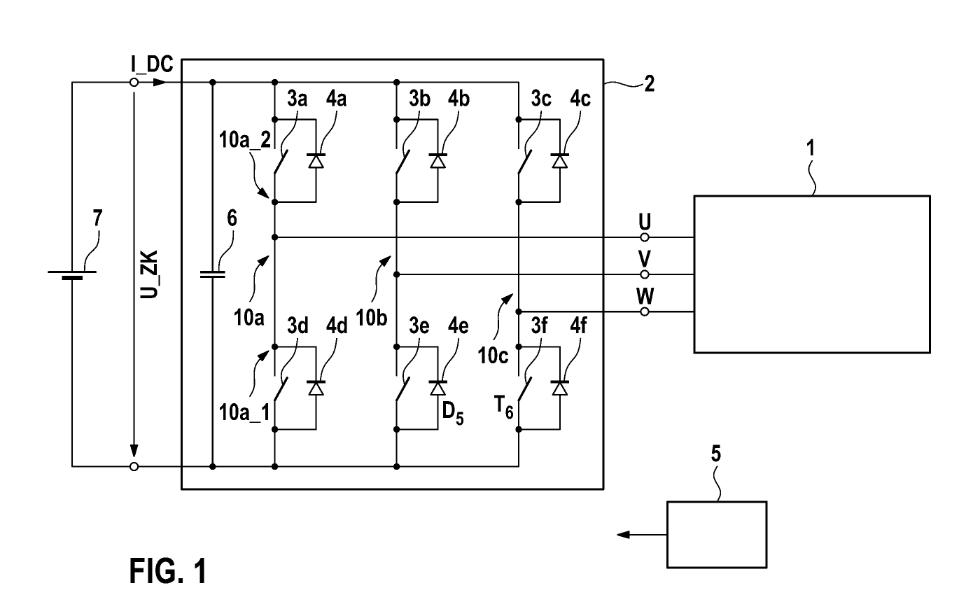

FIG. 1 shows a schematic representation of a three-phase electrical machine 1, which may take the form of a synchronous, asynchronous or reluctance machine, along with a pulse-controlled inverter 2 connected to it. Pulse-controlled inverter 2 includes controllable semiconductor switch elements 3a-3f in the form of power switches, which are connected to individual phases U, V, W of electrical machine 1 and connect phases U, V, W either to a high supply voltage potential in the form of intermediate circuit voltage U_ZK or to a low reference potential in the form of ground. In this context, the power switches 3a-3c connected to intermediate circuit voltage U_ZK are also referred to as “high-side switches,” and the power switches 3d-3f connected to ground are also referred to as “low-side switches,” and they may be manufactured, for example, as insulated gate bipolar transistors (IGBT) or as metal oxide semiconductor field effect transistors (MOSFET). Pulse-controlled inverter 2 further includes several non-controllable semiconductor switch elements in the form of free-wheeling diodes 4a-4f, which are positioned in parallel with power switches 3a-3f, respectively. In this context, power switches 3a and 3d, 3b and 3e, as well as 3c and 3f, form, together with the corresponding free-wheeling diodes, the half-bridges 10a, 10b and 10c, respectively. In this context, half-bridges 10a through 10c each include two parallel half-bridge branches; a half-bridge branch including, in each instance, a series connection of a high-side or low-side switch to the free-wheeling diode situated in parallel with the second power switch, thus, low-side or high-side switch, situated in the specific half-bridge. Thus, in the specific embodiment illustrated, this yields, for half-bridge 10a, a first half-bridge branch 10a_1, which includes a series connection of free-wheeling diode 4a and power switch 3d, and a second half-bridge branch 10a_2, which is connected in parallel with the first half-bridge branch and includes a series connection of power switch 3a and free-wheeling diode 4d. The specific half-bridge branches for the remaining half-bridges 10b and 10c are produced in an analogous manner.

Pulse-controlled inverter 2 determines the power and operating mode of electrical machine 1 and is correspondingly controlled by a control unit 5, which is only represented schematically in FIG. 1 and may also be integrated into inverter 2. In this context, electrical machine 1 is able to be operated selectively in motor mode or generator mode.

Pulse-controlled inverter 2 also includes a so-called intermediate circuit capacitor 6, which is mainly used for stabilizing a voltage of an energy store, thus, e.g., a battery voltage. The vehicle electrical system having the energy store in the form of a battery 7 is connected in parallel with intermediate circuit capacitor 6. Of course, as an alternative to the specific embodiment illustrated, intermediate circuit capacitor 6 may also be situated outside of pulse-controlled inverter 2.

In the exemplary embodiment illustrated, electrical machine 1 is manufactured to have three phases, but it may also have fewer or more than three phases; in each instance, a half-bridge having to be provided in pulse-controlled inverter 2 for each phase.

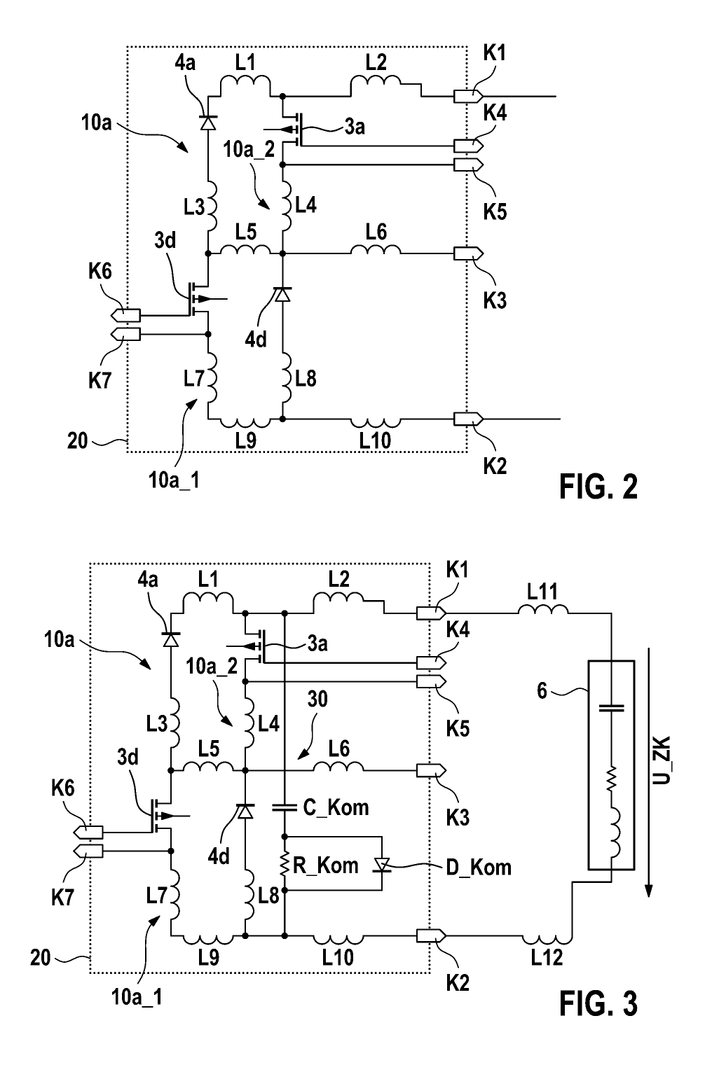

Each electrical connection between the individual components of the half-bridges, as well as the connecting lines to intermediate circuit capacitor 6, generate parasitic inductances, which, in FIG. 2, are exemplarily drawn in for half-bridge 10a, in the form of inductors L1 through L10. In this context, the half-bridge 10a having its parallelly connected half-bridge branches 10a_1 and 10a_2 is represented in contrast to the illustration in FIG. 1, in such a manner, that half-bridge branches 10a_1 and 10a_2 are more easily discernible. In this context, the electrical components of half-bridge 10a, that is, power switches 3a and 3d, as well as free-wheeling diodes 4a and 4d, are situated on a common circuit substrate 20, which is often also referred to as a printed circuit board (PCB) or, in the case of higher powers, as a DCB substrate (direct copper bond). Often, such a circuit substrate 10 including the applied components is also referred to as a half-bridge module or also a fabrication module. Accordingly, the half-bridge module includes terminals K1 through K7, via which the module is electrically connectible to other circuit modules or components.

When phase current I_U reverses direction from one of the power switches 3a or 3d to the free-wheeling diode 4d or 4a situated in the corresponding half-bridge branch, voltage surges, which are a function of the magnitude of the parasitic inductances and the current gradient, that is, the switching rate at which the current changes, occur at power switches 3a or 3d. Conversely, a voltage surge occurs at free-wheeling diodes 4a and 4d, when phase current I_U reverses direction from free-wheeling diode 4a or 4d to the power switch 3d or 3a situated in the corresponding half-bridge branch. In this context, the voltage surges occurring are also a function of the magnitude of the parasitic inductances and the current gradient, i.e., the switching rate at which the current changes.

FIG. 3 exemplarily shows an overvoltage protection circuit of the present invention for half-bridge 10a of FIG. 2. In this context, a commutation branch 30, which includes a commutation capacitor C_Kom, a commutation resistor R_Kom connected in series with it, and a commutation diode D_Kom connected in parallel with commutation resistor R_Kom, is connected in parallel with the two half-bridge branches 10a_1 and 10a_2. In addition, the intermediate circuit capacitor 6 connected between supply voltage terminals K1 and K2 is also represented in FIG. 3 in the form of an equivalent circuit diagram. Further parasitic inductances (connecting inductances) L11 and L12 are also illustrated in the leads to intermediate circuit capacitor 6.

In order to understand the function of commutation branch 30 more effectively, in the following, a situation, in which low-side switch 3d just opens, that is, a load current in the form of phase current I_U flows from output terminal K3 in the direction of power switch 3d, is used as a starting point. In this case, the load current reverses direction over to free-wheeling diode 4a of the affected half-bridge branch 10a_1. In the process, the parasitic inductors still carrying a current give off their energy. If a commutation branch is not provided, then all of the energy is delivered to the closing semiconductor switch element, that is, free-wheeling diode 4a. According to the law of induction, the voltage at the decommutating circuit element, thus, power switch 3d, climbs as high as the load current presently flowing requires. Simultaneously to that, free-wheeling diode 4a starts to receive load current; the parasitic inductances present in the corresponding branch delaying the increase in current. The voltage at power switch 3d only decreases again, when the energy stored in the inductors still carrying a current, and therefore, the current in power switch 3d, decreases. In this context, the magnitude of the occurring voltage surge is determined by the switching rate of power switch 3d, and by the magnitude of the parasitic inductances involved.

If, however, a commutation branch 30 of the present invention is connected parallelly to half-bridge branch 10a_1 or, in this case, half-bridge 10a, then a portion of the energy from the parasitic inductors still carrying a current is loaded into commutation capacitor C_Kom and converted into heat at commutation resistor R_Kom. Since the current flows through the commutation diode D_Kom connected in parallel with commutation resistor R_Kom, when commutation capacitor C_Kom is charged, the maximum voltage increase at commutation capacitor C_Kom and, therefore, at power switch 3d, is additionally reduced.

In this context, the magnitude of commutation resistor R_Kom becomes advantageously close to the aperiodic limiting case in the resonant circuit involved, which is formed by the commutation capacitor in conjunction with the parasitic inductances involved in the commutation operation. Accordingly,

$${R}_{Kom} \leq 2 * \sqrt{\frac{{L}_{Ges}}{{C}_{Kom}}} , \qquad ( 1 )$$

where L_Ges is the sum of all of the inductances involved in the commutation operation. This allows the current in commutation capacitor C_Kom to decay after 1 to 2 periods at a frequency

$$Ω = \sqrt{\frac{1}{{L}_{Ges} * {C}_{Kom}} - {( \frac{{R}_{Kom}}{2 * {L}_{Ges}} )}^{2}}$$

Besides the illustrated variant of the commutation branch 30 having a commutation capacitor C_Kom, a commutation resistor R_Kom and a commutation diode D_Kom, further specific embodiments are also conceivable. Thus, commutation branch 30 may only have one or more commutation capacitors. A specific embodiment having at least one commutation capacitor and at least one commutation resistor connected in series with it, but not having one or more commutation diodes connected to the commutation resistor, is also conceivable. However, commutation branch 30 may also include a series connection of at least one commutation capacitor, at least one commutation resistor and at least one commutation coil L_kom, which together form a series resonant circuit.

However, regardless of the specific embodiment of commutation branch 30, it is essential to the present invention that commutation branch 30 be connected to half-bridge branch 10a_1 or half-bridge 10a at an impedance that is as low as possible. According to the present invention, this is achieved by positioning components C_Kom, R_Kom, D_Kom, or also L_kom, of commutation branch 30 on the same circuit substrate 20, on which the components of half-bridge branch 10a-1 or half-bridge 10a are also situated.

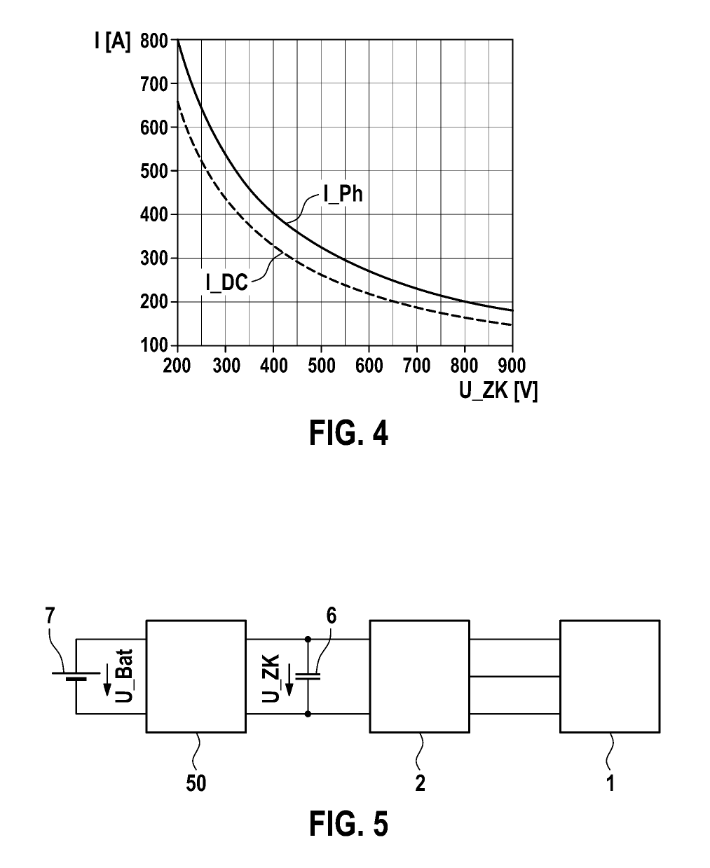

FIG. 4 shows a graphical representation of the phase current I_Ph (I_U, I_V, I_W) and supply current I_DC necessary to obtain a specified power in a circuit arrangement according to FIG. 1, as a function of intermediate circuit voltage U_ZK. One can see that with increasing intermediate circuit voltage U_ZK, lower phase currents and supply currents are sufficient for satisfying a specified power requirement.

However, since the nominal voltage of battery 7 may not be increased as needed, higher intermediate circuit voltages may only be produced with the aid of a d.c/d.c. voltage converter, which is often also referred to as a d.c./d.c. converter.

FIG. 5 shows a schematic block diagram of an electrical machine, which includes a d.c./d.c. voltage converter and is controlled by an inverter, as is known, for example from WO 2007/025946 A1. In this context, the set-up only differs from the set-up illustrated in FIG. 1, in that a d.c./d.c. voltage converter 50 is connected between battery 7 and intermediate circuit capacitor 6; in the generator mode of electrical machine 1, the d.c./d.c. voltage converter reducing intermediate circuit voltage U_ZK to the low level of battery voltage U_Bat, and in the motor mode, the d.c./d.c. voltage converter correspondingly increasing battery voltage U_Bat to the higher level of intermediate circuit voltage U_ZK.

An effort should be made to keep intermediate circuit capacitor 6, as well as charging inductors inside of d.c./d.c. voltage converter 50, as small as possible. This may be achieved by operating inverter 2 at an increased switching frequency, which, however, results in more rapid switching and, consequently, a greater current gradient, in the power switches and free-wheeling diodes. However, this increases the magnitude of the voltage surges caused by the parasitic inductances, which means that the use of a commutation branch of the present invention is particularly advantageous in such a set-up.

In this context, a commutation branch may, of course, be provided not only at the half-bridges of inverter 2, but also at half-bridges of d.c./d.c. voltage converter 50. In general, it should be noted that the overvoltage protection circuit of the present invention may be used, regardless of the specific application, for each circuit module that includes a half-bridge branch having a series connection of a controllable semiconductor switch element and a free-wheeling diode, since in spite of advancing technology, parasitic inductances may not be reduced as needed.

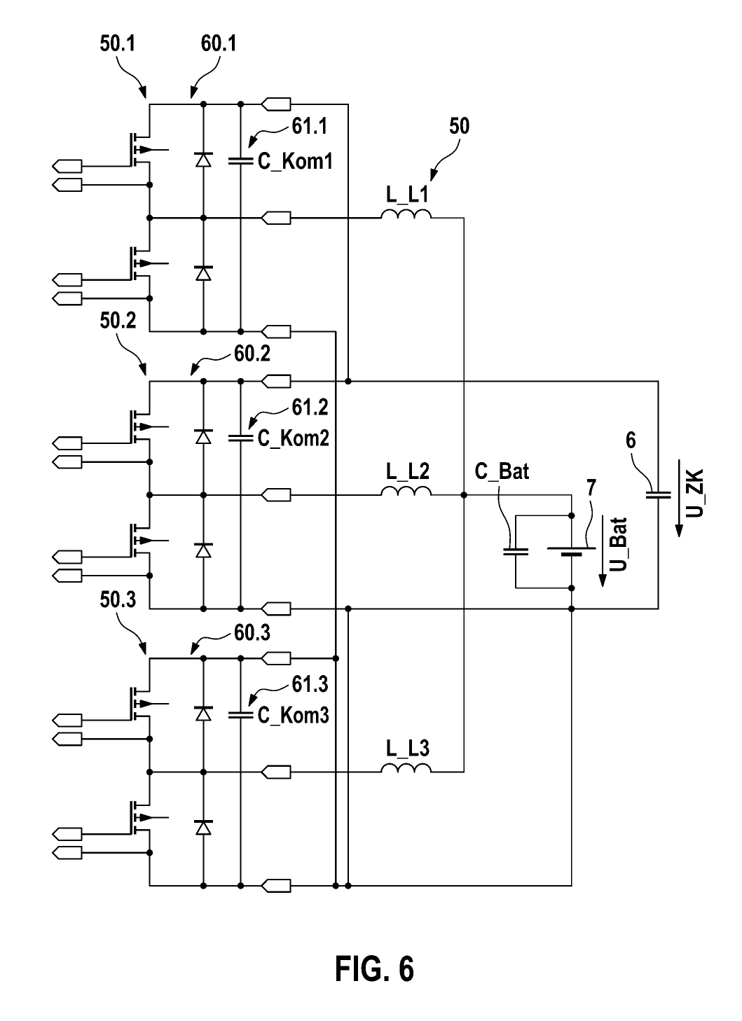

FIG. 6 shows d.c./d.c. voltage converter 50 of FIG. 3 in a somewhat more detailed illustration. In this instance, d.c./d.c. voltage converter 50 takes the form of a multiphase, in this case, three-phase, d.c./d.c. voltage converter. In this context, three identical d.c./d.c. voltage converters 50-1, 50-2 and 50-3, which include half-bridges 60-1, 60-2 and 60-3, respectively, as well as series-connected charging inductors L_L1, L_L2 and L_L3, respectively, are connected in parallel. In this context, half-bridges 60-1, 60-2 and 60-3 each include, in turn, two parallelly connected half-bridge branches; each half-bridge branch including a controllable semiconductor switch element and a free-wheeling diode connected in series with it. On the incoming side, d.c./d.c. voltage converter 50 is connected to battery 7, to which a capacitor C_Bat is parallelly connected for voltage stabilization. On the output side, d.c./d.c. voltage converter 50 is connected to intermediate circuit capacitor 6. In this context, the terms “on the incoming side” and “on the output side” refer to the motor mode of electrical machine 1. In this context, the specific embodiment as a multiphase d.c./d.c. voltage converter has the advantage that each of converters 50-1, 50-2 and 50-3 only has to carry a fraction of the total current, which means that, accordingly, charging inductors L_L1, L_L2 and L_L3, as well as the remaining passive components of the d.c./d.c. voltage converter, may be sized smaller. To that end, individual d.c./d.c. voltage converters 50-1, 50-2 and 50-3 may be clocked one after another in a time-staggered manner; that is to say, for a pulse duty factor specified by a controller, closing time T_E is divided up into three equal parts, and then, each of the three half-bridges 60-1, 60-2 and 60-3 is switched on one after another for, in each instance, a time span of T_E/3. Due to the parasitic inductances not illustrated in FIG. 6 for reasons of clarity, the above-mentioned voltage surges also occur in the branches of half-bridges 60-1, 60-2 and 60-3 of the d.c./d.c. voltage converter. Thus, commutation branches 61-1, 61-2 and 61-3, which include, for example, commutation capacitors C_Kom1, C_Kom2 and C_Kom3, respectively, are connected in parallel with half-bridges 60-1, 60-2 and 60-3, respectively; commutation capacitors C_Kom1, C_Kom2 and C_Kom3 being situated on the circuit substrates of corresponding half-bridges 60-1, 60-2 and 60-3, respectively.

1-9. (canceled)

10. An overvoltage protection circuit for at least one branch of a half-bridge circuit having a controllable semiconductor switch element and a free-wheeling diode connected in series and situated on a common circuit substrate, comprising:
a commutation branch connected in parallel with the at least one branch of the half-bridge circuit, wherein the commutation branch includes at least one commutation capacitor situated on the common circuit substrate.

11. The overvoltage protection circuit as recited in claim 10, wherein the commutation branch includes at least one commutation resistor connected in series with the commutation capacitor and situated on the common circuit substrate.

12. The overvoltage protection circuit as recited in claim 11, wherein the commutation branch includes at least one commutation diode connected in parallel with the commutation resistor and situated on the common circuit substrate.

13. The overvoltage protection circuit as recited in claim 11, wherein the commutation branch includes at least one commutation coil connected in series with the commutation capacitor and the commutation resistor, and wherein the commutation coil is situated on the common circuit substrate.

14. An inverter comprising:
semiconductor switch elements in the form of at least one half-bridge circuit having two parallel-connected branches, wherein each half-bridge branch includes a controllable semiconductor switch element and a free-wheeling diode connected in series and situated on a common circuit substrate; and
an overvoltage protection circuit provided for the at least one half-bridge circuit, wherein the overvoltage protection circuit includes a commutation branch connected in parallel with at least one branch of the half-bridge circuit, wherein the commutation branch includes at least one commutation capacitor situated on the common circuit substrate.

15. A DC/DC voltage converter, comprising:
semiconductor switch elements in the form of at least one half-bridge circuit having two parallel-connected branches, wherein each half-bridge branch includes a controllable semiconductor switch element and a free-wheeling diode connected in series and situated on a common circuit substrate; and
an overvoltage protection circuit provided for the at least one half-bridge circuit, wherein the overvoltage protection circuit includes a commutation branch connected in parallel with at least one branch of the half-bridge circuit, wherein the commutation branch includes at least one commutation capacitor situated on the common circuit substrate.

16. A circuit arrangement for operating an electrical machine, comprising:
a pulse-controlled inverter for controlling the electrical machine, wherein a half-bridge of the inverter is electrically connected to a phase of the electrical machine; and
an overvoltage protection circuit provided for the half-bridge, wherein the overvoltage protection circuit includes a commutation branch connected in parallel with at least one branch of the half-bridge, wherein the commutation branch includes at least one commutation capacitor.

17. The circuit arrangement as recited in claim 16, wherein:
an intermediate circuit capacitor is connected in parallel with the inverter; and
at least one DC/DC voltage converter is connected in parallel with the intermediate circuit capacitor, the DC/DC voltage converter including semiconductor switch elements in the form of at least one half-bridge circuit having two parallel-connected branches; and
an overvoltage protection circuit provided for the at least one half-bridge circuit, the overvoltage protection circuit including a commutation branch connected in parallel with at least one branch of the half-bridge circuit, and the commutation branch including at least one commutation capacitor.

18. The circuit arrangement as recited in claim 17, wherein:
multiple DC/DC voltage converters are connected in parallel to form a multiphase voltage converter, each DC/DC voltage converter including semiconductor switch elements in the form of at least one half-bridge circuit having two parallel-connected branches; and
an overvoltage protection circuit is provided for the at least one half-bridge circuit of each DC/DC voltage converter, the overvoltage protection circuit including a commutation branch connected in parallel with at least one branch of the half-bridge circuit, and the commutation branch including at least one commutation capacitor.
